(19) United States
(12) Patent Application Publication
(10) Pub. No.: US 2019/0154227 A1
(43) Pub. Date: May 23, 2019

(54) LIGHT-EMITTING DIODE LIGHTING SYSTEM AND SCANNING DEVICE, FOR AN AUTOMOTIVE VEHICLE HEADLIGHT

(71) Applicant: AML SYSTEMS, Paris (FR)

(72) Inventors: Hassan Koulouh, Le Pré Saint Gervais (FR); Cyril Rivier, Courbevoie (FR); Daniel Lopez, Gagny (FR)

(73) Assignee: AML SYSTEMS, Paris (FR)

(21) Appl. No.: 16/302,045

(22) PCT Filed: May 11, 2017
(86) PCT No.: PCT/FR2017/051147

§ 371 Date: Nov. 15, 2018

(30) Foreign Application Priority Data
May 17, 2016 (FR) 1654346

(51) Int. Cl. F21S 41/675; F21S 41/151; F21S 41/663

(52) U.S. Cl. CPC F21S 41/675; F21S 41/663; F21S 41/151

(57) ABSTRACT

A lighting system having a light source with a light-emitting diode and a scanning device receiving light radiation generated by the light source is provided. The scanning device generally includes a rotatably mobile reflection system and a unit for moving the reflection system. The light source configured such that a generally substantially rectangular light beam oriented along a vertical direction is emitted. The scanning device may be configured to scan the generally substantially rectangular light beam along a horizontal direction substantially orthogonal to the first direction carried out at a speed making it possible to benefit from a persistence of vision, and an activation/deactivation control of the light source may be synchronised with the scanning of the scanning device.

The field of the present invention is that of headlights and, more specifically, that of headlights for automotive vehicles.

Automotive vehicle headlights generally comprise a lighting system which generates and projects light on a reflector. The light is then sent onto a lens in order to be reversed and sent back in the form of a light beam outside of the vehicle.

It is known that it can be necessary to limit the range of such a headlight during the movement of the automotive vehicle, in particular to limit the range of the headlight, to that of dipped-beam headlights in order to not dazzle other drivers travelling in the opposite direction.

In addition, in an improved lighting, it can be provided to not illuminate certain specific parts of the lighting zone which could be illuminated by the lighting system, for example a zone part wherein is situated a vehicle coming from the front, or wherein is located an object, for example a mirrored panel, which is not desired to be illuminated.

Different conventional solutions are known, making it possible to adapt the shape of the light beam to the driving situation.

A first solution, mainly of the mechanical type, consists of using in the lighting system, a cutting mechanism which makes it possible to hide (or not) a part of the reflected beam. Usually, such a cutting mechanism generally comprises a rotating cutting strip. The cutting strip is actuated electrically to move it, on command, between two or several angular positions wherein it hides the light beam more or less.

This first mechanical solution, which is effective and less expensive, has the disadvantage of only being able to hide a limited number of zones.

To overcome this disadvantage, a second conventional solution is known, mainly of the optical type, which is configured to generate a beam matrix. Such a display system uses a matrix comprising an increased number of light-emitting diodes of LED type. This lighting system makes it possible, by a selective illumination and extinction of some of said light-emitting diodes, to not illuminate one or more of the parts of the lighting zone, capable of being covered by the lighting system.

With such a lighting system, it is possible to achieve a dynamic lighting, comprising several non-lit zones, or zones with reduced lighting, with a specific localisation, corresponding in particular to the position of vehicles coming in the opposite direction or of a vehicle preceding the automotive vehicle provided with the lighting system.

However, the lighting system of this second solution has the disadvantage of requiring an increased number of light-emitting diodes, generally around 20 to 80, which leads to an increased cost. In addition, in this second solution, it is provided, generally, to use laser diodes, of which the technology is not completely developed, and in any case, less developed than those of conventional light-emitting diodes.

The present invention aims to provide a display system which, while making it possible to implement a light-emitting diode-based lighting, does not have the disadvantages, in particular regarding cost, of the abovementioned usual second solution.

The invention relates to a lighting system for an automotive vehicle headlight, the lighting system comprising:
at least one light source comprising at least one light-emitting diode, said light source being configured to be able to be activated and deactivated and being capable of generating a light radiation when it is activated;
at least one focussing means; and
at least one scanning device receiving the light radiation generated by the light source and transmitted by the focussing means, the scanning device comprising at least one reflection system, rotatably mobile, and a unit for moving the reflection system, the scanning device being configured to reflect the light radiation and distribute it spatially by emitting a light beam.

According to the invention, at least said light source is configured so that a generally substantially rectangular light beam, oriented along a first direction termed vertical, is emitted, the scanning device is configured to scan the generally substantially rectangular light beam along a second direction termed horizontal, which is substantially orthogonal to said vertical direction, said scanning being carried out at a speed making it possible to benefit from a persistence of vision, and an activation/deactivation control of the light source is synchronised with the scanning of the scanning device.

Thus, thanks to the generation of a rectangular vertical light beam, associated with a horizontal scanning, it is possible to achieve lighting of a usual overall lighting zone of an automotive vehicle headlight, while using a reduced number of light-emitting diodes, which makes it possible to reduce the cost with respect to the abovementioned second conventional solution.

The unlit parts of zones (or zones having at least one reduced lighting) are obtained by synchronising the extinction of the light beam with the scanning thereof, i.e. by deactivating the light source at the moment when, during the scanning, the light beam is meant to be located at a zone part that is not desired to be illuminated.

To implement the invention, the scanning of the rectangular light beam is carried out at a very high speed in order to be able to benefit from a persistence of vision, i.e. so that the human eye sees a fully lit zone, despite the scanning. The persistence of vision is a phenomenon which attributes to the human eye, an afterimage on the retina, generally for a duration of around 1/25 of a second.

To this end, advantageously, the movement unit is configured to generate scanning of very high angular speed and greater, preferably, than 3000° per second.

Advantageously, the light source comprises a plurality of light-emitting diodes, arranged so as to form a set of diodes having a rectangular shape.

Furthermore, advantageously, the reflection system is mobile about an axis parallel to said vertical direction.

Moreover, in a first embodiment, the reflection system is configured to carry out a movement of complete rotation. In this case, advantageously, the reflection system has a cylindrical shape provided on the outer periphery thereof of a plurality of mirrors arranged on either side around the periphery.

Furthermore, in a second embodiment, the reflection system is configured to carry out a movement of oscillatory rotation, in a given angle of rotation, less than 180°.

Moreover, advantageously, the movement unit can comprise:
a direct current brushless motor; or
a piezoelectric motor.

The present invention also relates to a headlight for an automotive vehicle comprising at least one lighting system, such as that described above.

The present invention further relates to a method for controlling such a lighting system for an automotive vehicle headlight.

According to the invention, said method comprises a control step, consisting of synchronising the activation/deactivation of the light source with the scanning of the scanning device, so as to deactivate, if necessary, the light source for at least one given position of the light beam emitted, in order to obtain at least one non-lit part in a lighting zone (covered by the lighting system).

The invention will be best understood, and other aims, details, characteristics and advantages of this will appear more clearly during the following detailed explicatory description, of embodiments of the invention, giving purely illustrative and non-limiting examples, in reference to the appended schematic drawings. In these drawings:

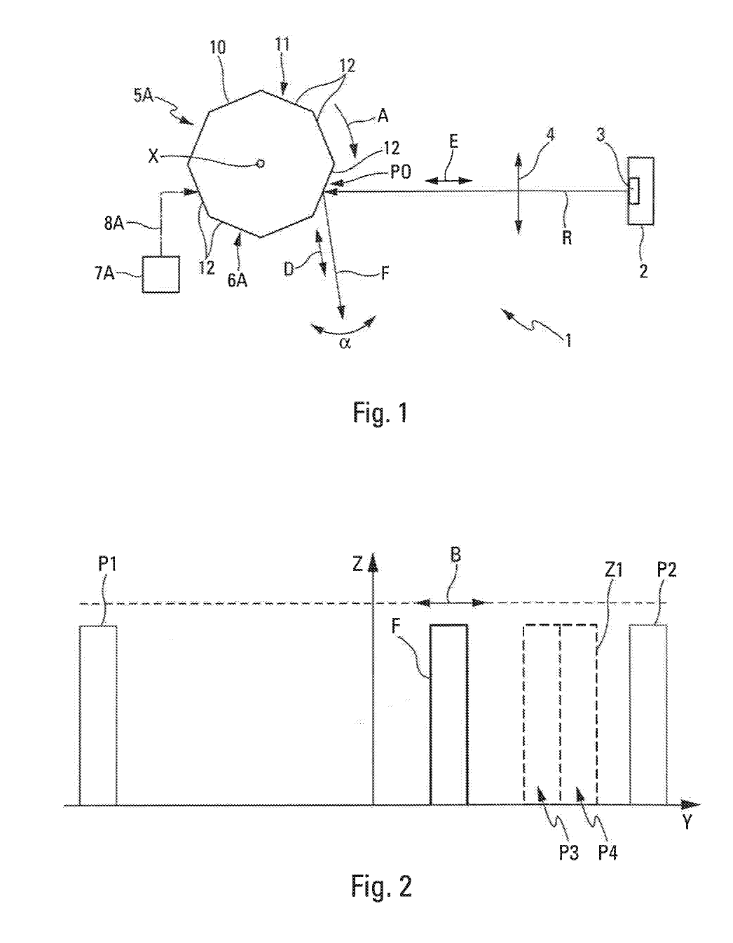

FIG. 1 is a schematic diagram of a lighting system according to a first embodiment;

FIG. 2 is a graph illustrating the scanning of a light beam;

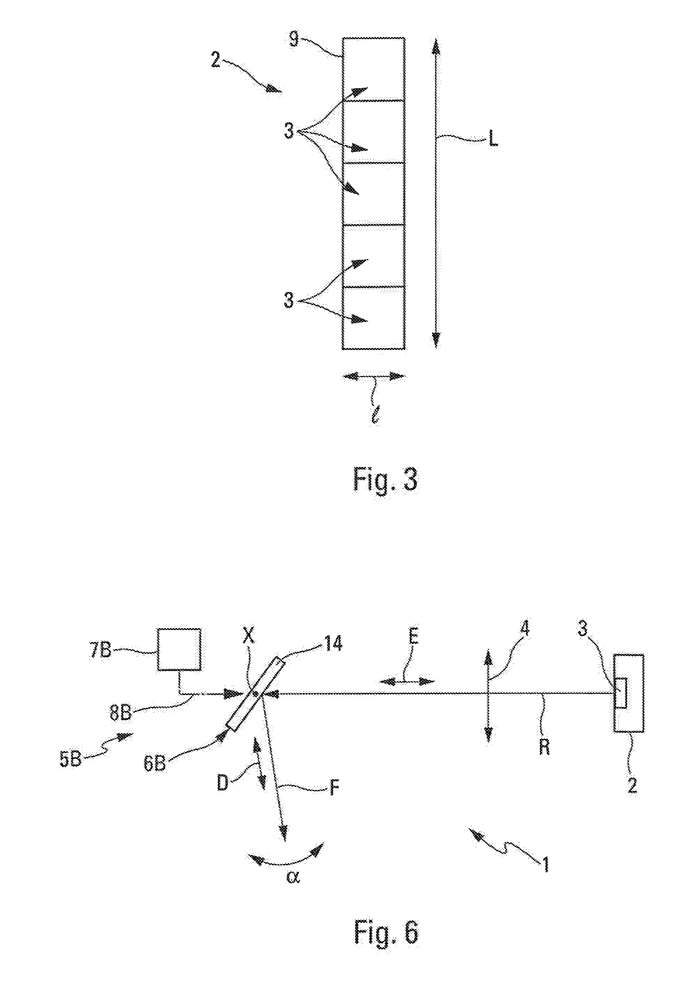

FIG. 3 schematically shows an example of an embodiment of a light source comprising a plurality of light-emitting diodes;

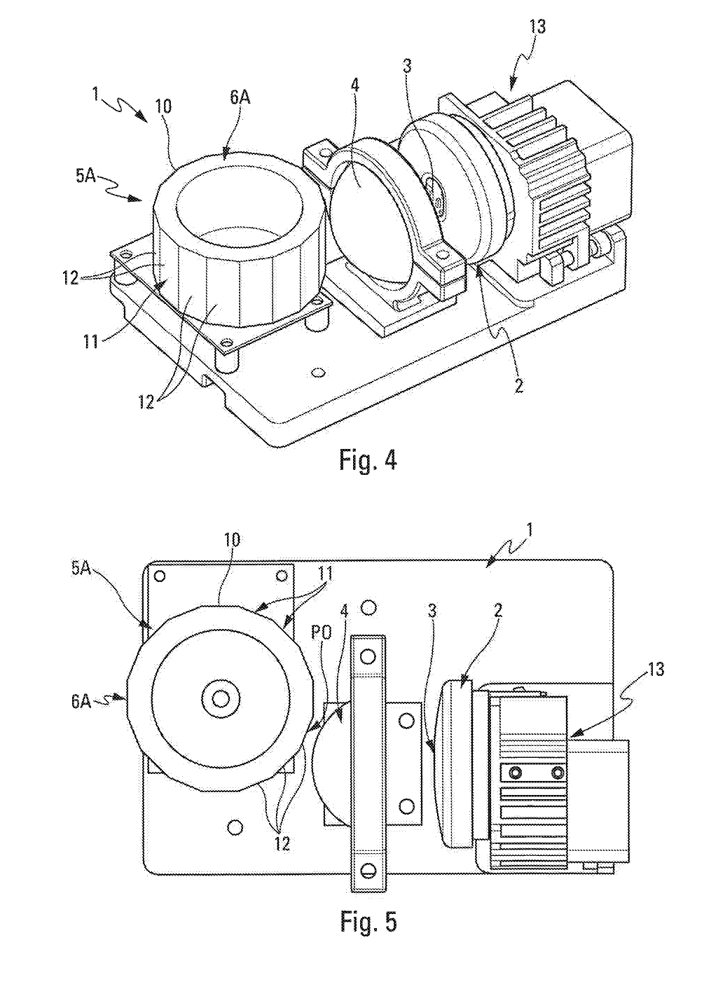

FIGS. 4 and 5 are schematic views, respectively in perspective and as a top plan view, of an example of an embodiment of the lighting system according to the first embodiment; and

FIG. 6 is a schematic diagram of a lighting system according to a second embodiment.

The present invention is applied to an automotive vehicle headlight (not shown), configured to generate a light beam. This headlight comprises a lighting system 1 such as schematically represented in FIG. 1.

This lighting system 1 is mounted inside a casing (not shown) of the headlight, facing a protective glass, to emit a light beam directed towards the road scene situated in front of the automotive vehicle.

As schematically represented in FIG. 1, the lighting system 1 comprises:
a light source 2 comprising at least one light-emitting diode 3, of LED type. The light source 2 is configured to be able to be activated or deactivated, i.e. that it can be controlled with the aim of illuminating or switching off the light-emitting diode(s) 3, and it is capable of generating a light radiation R when it is activated, using said light-emitting diode(s) 3;
a focussing means 4 (lens), in the focal plane of which is arranged the light source 2; and
a scanning device 5A, 5B which receives the light radiation R generated by the light source 2, reflects it and distributes it spatially by emitting a radiation (called light beam F in the scope of the present invention) which is projected outside of the headlight.

The scanning device 5A, 5B comprises at least one rotatably mobile reflection system 6A, 6B and a movement unit 7A, 7B, configured to move the reflection system 6A, 6B, as illustrated by an arrow 8A, 8B in a chain-dotted line in FIGS. 1 and 6.

The figure references to which the letter A is associated, relate to a first embodiment of the scanning device, shown in FIG. 1, while the figure references to which the letter B is associated, relate to a second embodiment shown in FIG. 6.

According to the invention:
at least said light source 2 is configured so that a generally substantially rectangular light beam F, is emitted, as shown in FIG. 2. This light beam F is oriented (by the length thereof) along a first direction Z termed vertical;
the scanning device 5A, 5B is configured to scan the (generally substantially rectangular) light beam F along a second direction Y termed horizontal, which is substantially orthogonal to said vertical direction Z, as illustrated by an arrow B in FIG. 2. The scanning is carried out between two extreme positions P1 and P2 represented by a thin continuous line. In the mounted position of the headlight on the automotive vehicle, the direction Z substantially corresponds to the vertical direction with respect to the ground and the direction Y substantially corresponds to a horizontal direction, transverse to the automotive vehicle;
the scanning is carried out at an increased speed which is such that it makes it possible for a human eye to benefit from a persistence of vision, as specified below; and
the activation/deactivation control of the light source 2 is synchronised with the scanning produced by the scanning device 5A, 5B.

Thus, thanks to the generation of a vertical rectangular light beam F (along the direction Z), associated with a horizontal scanning (along the direction Y) of this light beam F, the lighting system 1 is able to illuminate an overall usual lighting zone (laterally delimited by the positions P1 and P2 of FIG. 2) of an automotive vehicle headlight, while using a reduced number of light-emitting diodes, preferably 1 to 8 light-emitting diodes.

The lighting system 1 thus has a reduced cost, all the more than being able to use conventional (non-laser) light-emitting diodes which are cheaper.

The lighting system 1, such as described above, is able to create, in the lighting zone, one or more non-lit zone parts (or zone parts all having at least one reduced lighting). This or these zone part(s) are obtained by synchronising the extinction of the light beam F at the level of the light source 2 with the scanning thereof, i.e. by deactivating the light source 2 at the moment when, during the scanning, the light beam F is meant to be located at a zone part that is not desired to be illuminated, as illustrated for a zone part Z1 in FIG. 2. This zone part Z1 represented by dashes encompasses two successive lateral positions P2 and P3 of the rectangular light beam F.

The lighting system 1 is able to create, in the lighting zone, a plurality of different zone parts, non-lit (or all having at least one reduced lighting), thus generating a dynamic and selective lighting.

For the implementation of the invention, the scanning of the rectangular light beam is therefore carried out at a very high speed, in order to be able to benefit from a persistence of vision, i.e. so that the human eye sees a fully lit zone, despite the scanning.

To do this, the movement unit 7A, 7B is configured to generate a movement of the reflection system 6A, 6B, creating scanning of very high angular speed and greater, preferably, than 3000° per second.

As an illustration, with a scanning speed of frequency 100 Hz for an angular range of 40°, an angular speed of 4000° per second is obtained.

The lighting system 1 is associated with a control unit (not shown which controls the synchronisation of the activation/deactivation of the light source 2 with the scanning of the lighting device 5, by usually generating suitable control orders, which are sent to the light source 2 (and possibly to the movement unit) according to the angular position of the light beam emitted.

Information relating to zone parts to not be illuminated, which are used to determine these control orders, are generated usually, for example using a camera for detecting an approaching vehicle. Acquiring this information does not come within the scope of the present invention and is not described further.

In a preferred embodiment shown in FIG. 3, the light source 2 comprises a plurality of light-emitting diodes 3, arranged so as to form a set of diodes 9 having a rectangular shape.

In the example shown in FIG. 3, the set of diodes 9 comprises five light-emitting diodes 3 of identical square shapes. In this example, the length L of the set of diodes 9 is therefore equal to five times the length/thereof.

In this preferred embodiment, the rectangular shape of the light beam F emitted is created directly by the rectangular shape of the light source 2 generating the light beam R.

However, within the scope of the present invention, the rectangular light beam F can be created in different ways, in particular by a specific combination of the light source (with light-emitting diode(s)) and an optical shape generation means (not shown).

The reflection system 6A, 6B is mobile about an axis X which is parallel to said vertical direction Z.

In a first embodiment shown in FIGS. 1, 4 and 5, the reflection system 6A is configured to carry out a complete rotational movement, for example in the direction illustrated by an arrow A in FIG. 1.

In this case, the reflection system 6A comprises a cylindrical part 10, having a symmetry of rotation about the axis X, which is provided on the outer periphery 11 thereof of a plurality of mirrors 12 (for example, eight or sixteen mirrors), arranged on either side around the periphery (or circumference). This cylindrical part 10 is driven in rotation by the movement unit 7A.

During the rotation of the reflection system 6A, the light radiation R is reflected successively, one after the other, by the mirrors which are arranged on either side, and at each moment by the mirror which is located at a position P0 facing the focussing means 4. In addition, because of the rotation of the reflection system 6A, which modifies the relative position of the mirror (achieving the reflection) with respect to the direction E for transmitting the light radiation R, the direction D for emitting the light beam F varies. This direction is within an angular range of angle α which preferably has a value 40° or 60°, i.e. with values of +/−20° or of +/−30° on either side of a central angular position.

In the examples in FIGS. 4 and 5, the movement unit which drives the reflection system 6A has not been shown. However, these FIGS. 4 and 5 show a radiator 13 intended to receive the light source 2 provided with a light-emitting diode 3.

Furthermore, in a second embodiment, schematically shown in FIG. 6, the reflection system 6B comprises a mirror 14 and it is configured to carry out a movement of oscillatory rotation under the action of the movement unit 7B, in a given angular range a, less than 180°, for example in an angular range of 40°.

In the scope of the present invention, the movement unit 7A, 7B can comprise any type of motor capable of implementing the of rotational or oscillatory movement in question. In a specific embodiment, it can comprise:
a direct current brushless motor; or
a piezoelectric motor.

The functioning of the lighting system 1, such as described above, is as follows.

The lighting system 1 generates, using at least the light source 2, a vertical rectangular light beam F (along the direction Z). Simultaneously, the scanning device 5A, 5B carries out horizontal scanning of the vertical light beam F, along the direction Y.

The lighting system 1 thus scans an overall usual lighting zone of an automotive vehicle headlight.

The scanning of the rectangular light beam F is carried out at a very high speed, in order to benefit from a persistence of vision.

In addition, the lighting system 1 synchronises the activation and the deactivation of the light source 2 with the scanning of the scanning device 5A, 5B, so as to deactivate, if necessary, the light source 2 for at least one given position of the light beam emitted, in order to obtain at least one non-lit part in a lighting zone. The lighting system 1 thus generates a controllable dynamic lighting.

1. A lighting system for an automotive vehicle headlight, the lighting system comprising:
a light source comprising a light-emitting diode, said light source configured to selectively activate and deactivate and, when activated, generate a light radiation;
a focusing means; and
a scanning device receiving the light radiation generated by the light source and transmitted by the focusing means, the scanning device comprising:
at least one rotatably mobile reflection system; and
a unit configured to move the reflection system, the scanning device configured to reflect and to distribute the light radiation spatially by emitting a light beam,
wherein at least said light source is configured such that a generally substantially rectangular light beam, oriented along a vertical direction, is emitted,
wherein the scanning device is configured to scan the generally substantially rectangular light beam along a horizontal substantially orthogonal to said vertical direction,
wherein the scanning is carried out at a speed making it possible to benefit from a persistence of vision, and
wherein an activation/deactivation control of the light source is synchronised with the scanning of the scanning device.

2. The lighting system according to claim 1, wherein the activation/deactivation control of the light source is synchronised with the scanning of the scanning device, such that the light source is deactivated for at least one given position of the light beam emitted during the scanning, to obtain at least one non-lit part in a lighting zone of the lighting system.

3. The lighting system according to claim 1, wherein the light source comprises a plurality of light-emitting diodes arranged to form a set of diodes having a rectangular shape.

4. The lighting system according to claim 1, wherein the reflection system is mobile about an axis parallel to said vertical direction.

5. The lighting system according to claim 4, wherein the reflection system is configured to carry out a complete rotational movement of the light beam.

6. The lighting system according to claim 5, wherein the reflection system comprises a cylindrical part disposed on an outer periphery of the reflection system and having a plurality of mirrors arranged on either side around the outer periphery.

7. The lighting system according claim 4, wherein the reflection system is configured to carry out an oscillatory rotational movement of the light beam, the oscillatory rotational movement having an angle of rotation less than 180°.

8. The lighting system according to claim 1, wherein the unit comprises a direct current brushless motor.

9. The lighting system according to claim 1, wherein the unit comprises a piezoelectric motor.

10. The lighting system according to claim 1, wherein the unit is configured to move the scanning device at an angular speed greater than 3000° per second.

11. A headlight for an automotive vehicle comprising one or more lighting systems of claim 1.

12. A method for controlling an automotive vehicle headlight having the lighting system of claim 1, comprising synchronising the activation/deactivation of the light source with the scanning of the scanning device, so as to deactivate, if necessary, the light source for at least one given position of the light beam emitted, to obtain at least one non-lit part in a lighting zone.
